(19) United States
(12) Patent Application Publication
(10) Pub. No.: US 2009/0115261 A1
(43) Pub. Date: May 7, 2009

(54) Air Floating Linear Motor

(76) Inventors: Kou-I Szu, Taichung (TW); Don-Hua Cheng, Taichung (TW)

Correspondence Address: Dr. BANGER SHIA, 102 Lindencrest Ct., Sugar Land, TX, 77479-5201, US

(21) Appl. No.: 11/936,688

(22) Filed: Nov. 7, 2007

(51) Int. Cl. H02K 41/02

(52) U.S. Cl. 310/12

(57) ABSTRACT

An air floating linear motor comprises a fixed part and a movable part. The movable part floats above the fixed part. The movable moves with respect to the fixed part by the magnetic interaction. The fixed part is disposed with a receiving portion for assembling an external device such as a position feedback device or a travel protection device, etc. Therefore, the air floating linear motor is much more simplified and convenient in fabrication and installation.

### BACKGROUND OF THE INVENTION

1. Field of the Invention

The present invention relates to a linear motor, and more particularly to an air floating motor which allows a movable part to float above a fixed part.

2. Description of the Prior Art

The linear motor has a quite wide application field. As for a movement between a movable part and a fixed part, in order to make the displacement much smoother, the two parts may be equipped with balls or a slideway and a guideway to move. In addition, the movable part can be disposed with an air jet device, so that the movable part can float above the fixed part to move due to the push force caused by discharging air.

As to the linear motor whose movable part floats above the fixed part, as shown in FIG. 1, a conventional linear motor comprises a fixed part 10 which is equipped with a magnetic rail 11 and a movable part 20 equipped with an air jet device (not shown) and a magnetic device (not shown). When the movable part 20 floats above the fixed part 10 by use of the air jet device, the movable part 20 can float and move above the fixed part 10 due to the magnetic interaction between the magnetic rail 11 and the magnetic device of the fixed part 10 of the movable part 20.

However, it can be found that, if this kind of air floating linear motor is to be additionally assembled with an external device such as a position feedback device or a travel protection device, neither the fixed part 10 nor the movable part 20 has any space for assembling. Therefore, the fixed part 10 has to be additionally installed with a bottom board for assembling the external device, thus leading to the extra cost and working procedure.

The present invention has arisen to mitigate and/or obviate the afore-described disadvantages.

### SUMMARY OF THE INVENTION

The primary objective of the present invention is to provide an air floating linear motor inside which an external device can be assembled.

In order to achieve the above objective, the air floating linear motor in accordance with the present invention comprises a fixed part and a movable part. The fixed part is disposed with a magnetic rail and a receiving portion. The movable part is disposed with an air jet device and a magnetic device. The movable utilizes the air jet device to jet out air to float with respect to the fixed part. The magnetic rail of the fixed part and the magnetic device of the movable part magnetically interact with each other.

Hence, an external device such as a position feedback device or a travel protection device can be assembled in the receiving space of the fixed part without additionally assembling a bottom board to the fixed part, thus saving the extra cost and working procedure.

### BRIEF DESCRIPTION OF THE DRAWINGS

FIG. 1 is a plan view showing a conventional air floating linear motor;

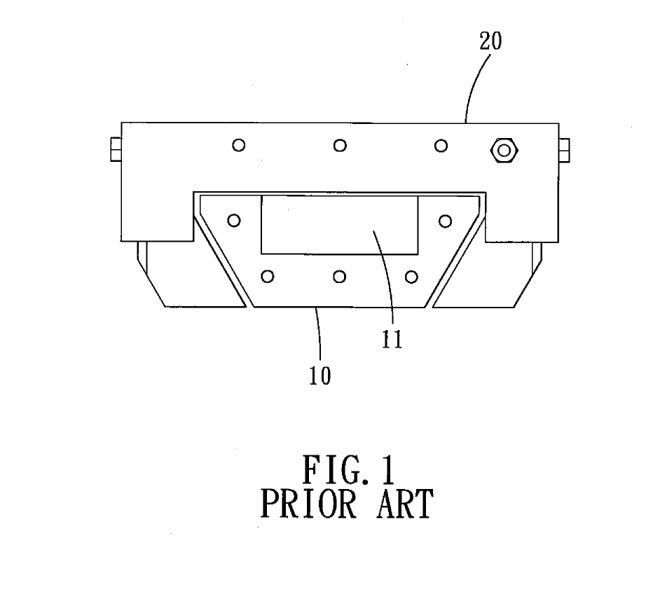

FIG. 2 is a perspective view of an air floating linear motor in accordance with the present invention;

FIG. 3 is a plan view showing the air floating linear motor in accordance with the present invention; and

FIG. 4 is a plan view showing a receiving portion is being assembled with an external device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

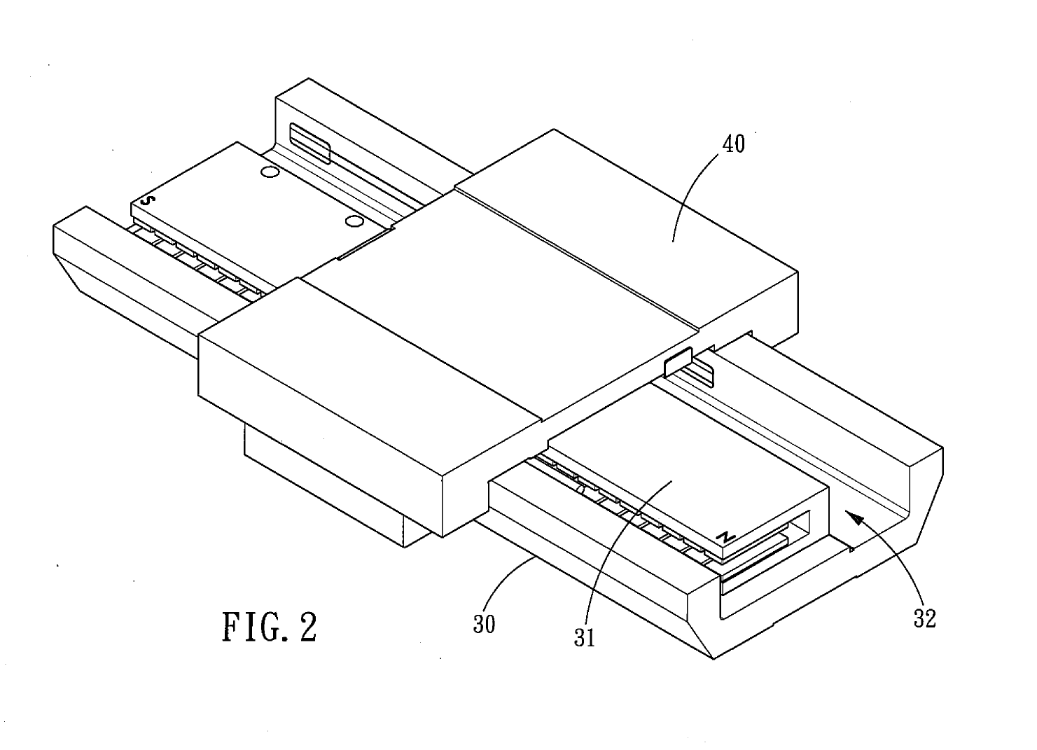

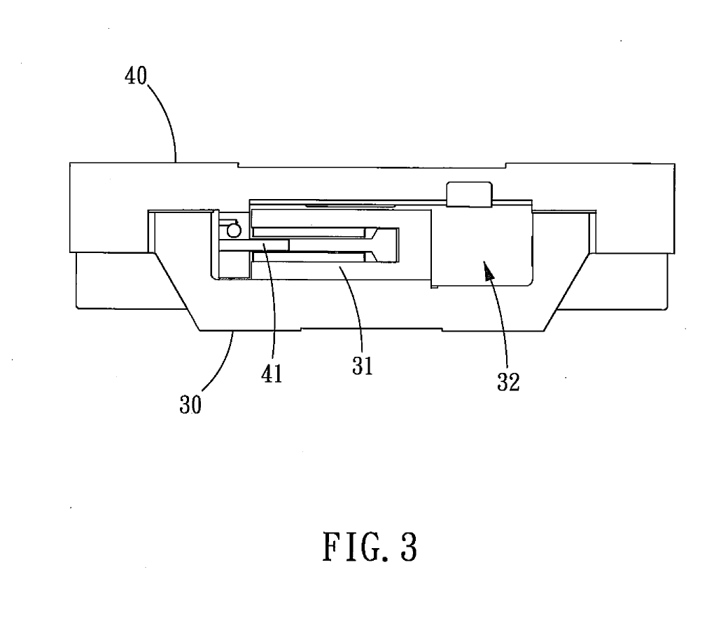

Referring to FIGS. 2-3, an air floating linear motor in accordance with a preferred embodiment of the present invention comprises a fixed part 30 and a movable part 40.

The fixed part 30 is an elongated structure and disposed with a magnetic rail 30 and a receiving portion 32. The magnetic rail 31 extends in an extension direction of the fixed part 30. The receiving portion 32 is located adjacent to the magnetic rail 31 and also extends in the extension direction of the fixed part 30. The receiving portion 32 is opened towards an upper side of the fixed part 30.

The movable part 40 includes an air jet device (not shown) and a magnetic device 41. The movable part 40 is disposed on the upper side of the fixed part 30 and opposite the receiving portion 32 of the fixed part 30, so as to make the movable part 40 be located in the open direction of the receiving portion 32. The movable part 40 utilizes the air jet device to jet out air towards the fixed part 32, so as to allow it to float above the upper side of the fixed part 30. The magnetic interaction between the magnetic rail 31 of the fixed part 30 and the magnetic device 41 of the movable part 40 can be used to make the movable part 40 move with respect to the fixed part 30. Since the air jet device, the magnetic device 41 and the air floating and the movement of the movable part 40 with respect to the fixed part 30 are all the conventional technology, more detailed explanations are omitted here.

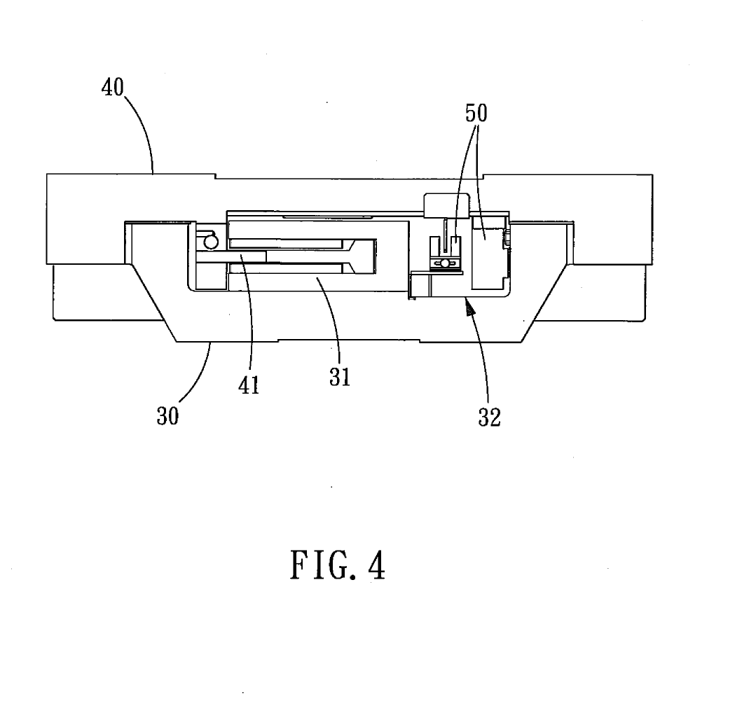

As shown in FIG. 4, an external device 50 can be assembled in the receiving portion 32 of the fixed part 30, and the external device 50 may be a position feedback device (for example, an optical scale) or a travel protection device and so on. The external device 50 needs to be electrically connected to the fixed part 30 and the movable part 40. However, since the electrical connection between the external device 50 and the fixed part 30 or the movable part 40 is still a conventional technology, more detailed explanations are omitted here too.

Hence, the air floating linear motor in accordance with the present invention can directly assemble the external device 50 in the receiving portion 32 of the fixed part 30 without an extra mounted bottom board, thus not only saving the space for assembling the external device 50, but saving the processing cost, working procedure and working time due to without additionally assembling the bottom board to the fixed part.

While we have shown and described various embodiments in accordance with the present invention, it is clear to those skilled in the art that further embodiments may be made without departing from the scope of the present invention.

What is claimed is:

1. An air floating linear motor comprising:
a fixed part including a magnetic rail and a receiving portion, the receiving portion being opened towards one side of the fixed part; and
a movable part including an air jet device and a magnetic device, the movable part floating with respect to the fixed part by use of the air jet device, the movable part is opposite the receiving portion of the fixed part, so that the movable part is located in an open direction of the receiving portion, and the magnetic device of the movable part and the magnetic rail of the fixed part magnetically interact with each other.

2. The air floating linear motor as claimed in claim 1, wherein the fixed part is elongated, and both the magnetic rail and the receiving portion of the fixed part extend in an extension direction of the fixed part.

3. An air floating linear motor comprising:
a fixed part including a magnetic rail and a receiving portion; and
a movable part including an air jet device and a magnetic device, the movable part floating with respect to the fixed part by use of the air jet device, the magnetic device of the movable part and the magnetic rail of the fixed part magnetically interact with each other; and
at least one external device being disposed in the receiving portion of the fixed part.

4. The air floating linear motor as claimed in claim 3, wherein the fixed part is elongated, and both the magnetic rail and the receiving portion of the fixed part extend in an extension direction of the fixed part.

5. The air floating linear motor as claimed in claim 3, wherein the external device is a position feedback device or a travel protection device.

6. The air floating linear motor as claimed in claim 3, wherein the external device is an optical scale.

7. The air floating linear motor as claimed in claim 3, wherein the receiving portion of the fixed part is opened towards one side of the fixed part, and the movable part is opposite the receiving portion of the fixed part and located in an open direction of the receiving portion.
